(19) United States
(12) Patent Application Publication
(10) Pub. No.: US 2008/0077952 A1
(43) Pub. Date: Mar. 27, 2008

(54) Dynamic Association of Advertisements and Digital Video Content, and Overlay of Advertisements on Content

(76) Inventors: Randy St. Jean, San Francisco, CA (US); Edward G. Klein, South San Francisco, CA (US); Mitchell Linden, Albany, CA (US); Cynthia J. Francis, Napa, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/861,235

(22) Filed: Sep. 25, 2007

Related U.S. Application Data
(60) Provisional application No. 60/826,896, filed on Sep. 25, 2006.

(51) Int. Cl. H04N 7/10

(52) U.S. Cl. 725/32

(57) ABSTRACT

In response to a user selection of a media item, such as a video clip, from a website for online sharing of media, the website selects an advertisement to pair with the requested media item. The selection of the advertisement may be based on information known about the requested media item, thereby resulting in a more targeted advertisement based on the own identification of content that interests the user. The website may pair the advertisement as an overlay with the media item. The paired item and advertisement are delivered to the user, who can view them on a local device.

### CROSS REFERENCE TO RELATED APPLICATIONS

This application claims the benefit of U.S. Provisional Application No. 60/826,896, filed Sep. 25, 2006, which is incorporated by reference in its entirety.

### BACKGROUND

This invention relates generally to associating advertisements with relevant media content, such as using overlays of the advertisements over video content obtained on a media sharing website.

Advertisers are interested in reaching online audiences, in which the 18 to 25 year-old market demographic is strongly represented. Especially within this demographic, online users use the latest features on the Internet. One of the latest advancements and a very popular online activity for this demographic revolves around the sharing of consumer-created video or other user-generated content (UGC). Although the content can be shared in many ways, a common way is via community sharing websites.

Many content sharing websites rely on advertising as their primary source of revenue; however, advertisers are reticent to connect their brand to websites that show content that is “risqué” or in any way potentially damaging to their brand. This is in part because many UGC websites are not moderated consistently and/or the content on the websites is not appropriately screened. Advertisers therefore cannot control the content with which their advertisements are associated. As such, advertisers are reluctant to place their brands or product advertisements on UGC websites.

Another problem encountered is how to present advertisements along with video content effectively and with the greatest likelihood that the advertisements are actually watched. Advertisements that are shown before or after a downloaded video stream (such as streaming media content sent over the Internet) may not be viewed because viewers may in some cases avoid the advertisements. Depending on the implementation of the advertisements, viewers may avoid them, e.g., by skipping past the advertisement, closing the window during the advertisement, or simply turning their attention away while the advertisement is playing.

### SUMMARY

To address these and other deficiencies in systems for pairing advertisements with video content online, embodiments of the invention select advertisements to be presented with media content available on a media sharing website. The advertisements, selected according to any of a number of criteria, are combined with the media content and presented to the users. In one embodiment, the media content is a video clip, and the advertisements are combined with the video clips.

In accordance with one embodiment of the invention, an advertisement is presented as an opaque overlay on top of a media item, such as a video clip. The advertisement need not cover the entire player window when the video clip is being played, but it may be designed to fade in and out based on how it is configured by the advertiser or by the customer.

To increase the impact or effectiveness of an advertising campaign, an advertiser may wish to target particular advertisements to a particular set of consumers. In various embodiments of the invention, this targeting may be done by linking advertisements to content that is relevant to a particular media item. Consumers of the media items will generally tend to select media items that are interesting to them. By linking advertisements to media items, advertisers can direct their advertisements to consumers who have already self-selected themselves as being interested in a particular topic. This results in a more effective targeting campaign and one in which advertisers can leverage on consumers' activity to direct advertising.

Linking an advertisement to a media item can be performed in various ways. In one embodiment, an advertiser selects words or phrases to be associated with their advertising or brand (e.g., “baseball,” “sports,” and “summer” for a soft-drink company, or “clothing,” “fashion,” and “teen” for a clothing retailer). The corresponding advertisements are then used only for those video clips that are also associated with these predetermined words in their keyword tagging, title, or description. In other embodiments, the system automatically extracts information about the content of the media item from the media item itself, using any of a variety of known content recognition techniques. Other techniques for linking advertisements to media items may be used as well, in combination or alone.

### BRIEF DESCRIPTION OF THE DRAWINGS

FIG. 1 is a diagram of a process flow in accordance with an embodiment of the invention.

FIG. 2 is a diagram of a system for performing an embodiment of the invention.

FIG. 3 is an interaction diagram of a method in accordance with an embodiment of the invention.

FIG. 4 is a diagram of a business model in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

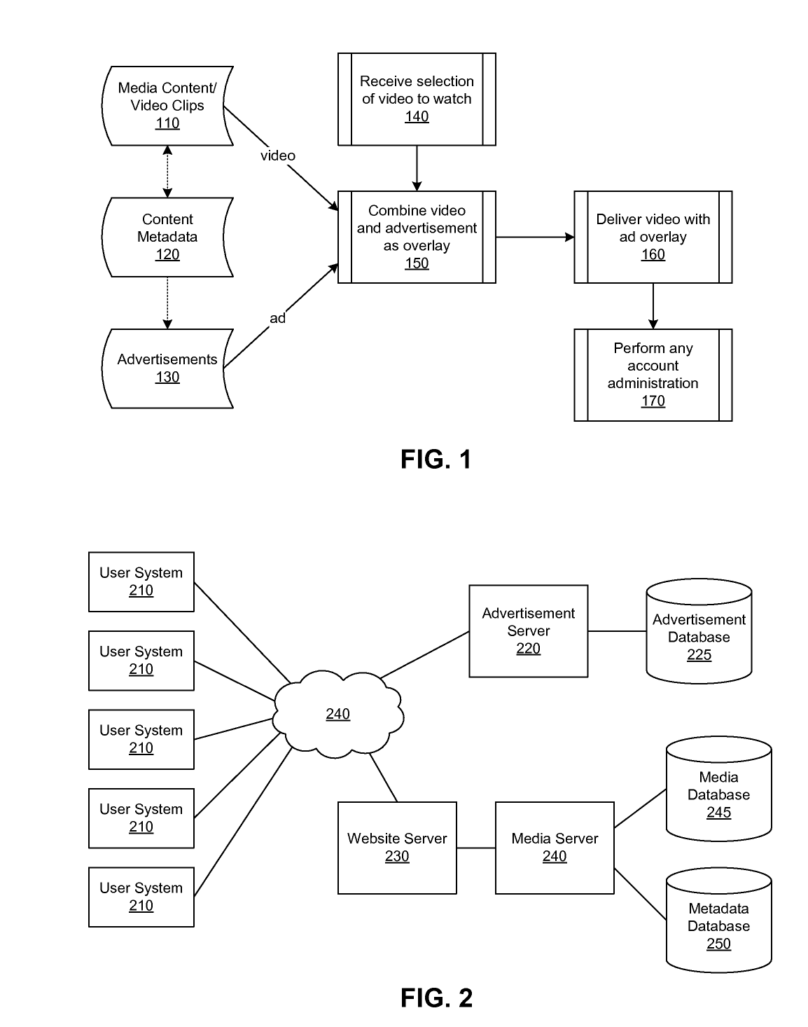

FIG. 1 illustrates a process in accordance with an embodiment of the invention. As shown in FIG. 1, three basic sets of information are used: media content 110 (which may comprise discrete media items), content metadata 120 associated with the media content 110, and advertisements 130. In one embodiment, the media items comprise video segments or video clips, although other forms of media may be used in other embodiments of the invention. The metadata 120 contain information that described the media items 110 or otherwise provides information useful in linking advertisements 130 to the media items 110. The advertisements 130 may comprise a variety of different types of content, such as pictorial or video overlays that can be added to a video clip, audio that can be played in combination with a media item, interactive content (such as a clickable hyperlink) that can be presented with the media item, or any of a variety of other forms of advertising that can be used with the media items 110.

A selection 140 may be made for a particular one or more of the items of media content 110. For example, a user may request a video clip from a video sharing website, as explained in more detail below. In response receiving a selection 140 for a particular item of the media content 110, the system links the selected media item 110 to an advertisement 130. This linking is performed according to a set of criteria associated with the advertisements 130 and the information about the media content item 110 as reflected in the metadata 120. For example, the advertisements may be associated with a set of keywords, and the selected advertisements 130 to be paired with the requested media item 110 may be one whose associated metadata 120 contains the keyword.

The selected advertisement 130 is then combined 150 with the media item 110. In one embodiment, the media item 110 comprises a video clip, and the advertisement 130 is combined 150 as an overlay during at least a portion of the video clip. Once the advertisement 130 and content item 110 are combined in this way, this enhanced content is then delivered 160 to the requesting party, such as a user of the website.

In one embodiment, an account administration system allows administrators to set up accounts for advertiser clients and to configure the advertisements that belong to those clients. Depending on whether a business model is being implemented based on the delivery of the advertisements, as described in more detail below, the system may perform 170 account administration based on this delivery. Advertisers may thus purchase advertisements 130 for specific media items 110 or for media items 110 that match specific tag words, descriptions/titles, topics, or other custom criteria. The administration system may provide reports so that advertisers can estimate how many views their advertisements 130 are likely to receive based on recent history. Advertisements 130 may be configured to be automatically activated on a particular start date and deactivated on a particular stop date.

FIG. 2 illustrates a system architecture in which the process may be performed. This system allows multiple end-users or viewers to access a website to upload media content and to view media content uploaded by others. In this architecture, viewer may access the media by connecting their user systems 210 to a website via a network 240. User systems 210 may comprise any computing device capable of accessing and playing media, including personal computers, cell phones, and any other suitable computing devices. The user system may access the website via a network 240 such as the Internet.

The website, such as a community UGC sharing website, is implemented with a website server 230. The website server 230 has access to a media server 240, which can provide the media content and its associated metadata as stored in a media database 245 and a metadata database 250, respectively. The website server 230 may use a distributed architecture for media uploading, media encoding, media storage, and media streaming or playback.

The system further comprises an advertising server 220, which provides access to an advertisement database 225. The advertising server 220 that holds and streams the advertisements 130 may be managed either by a business customer (e.g., an advertiser) on one or more servers remote from the website, or the advertising server 220 may be managed by the same operator as the website. In either case, the advertisements 130 may be linked to the digital media content 110 at the time that a specific video playback request is made by the viewer. In one embodiment, the system comprises an ad-serving engine by itself or an ad-serving engine in conjunction with an existing third-party ad-serving engine.

Embodiments of the invention thus provide a software platform for business-centric UGC that addresses many of these concerns. Using a hosted service, a business can add UGC capability and content to their existing website, or to create a new stand-alone UGC site for their business.

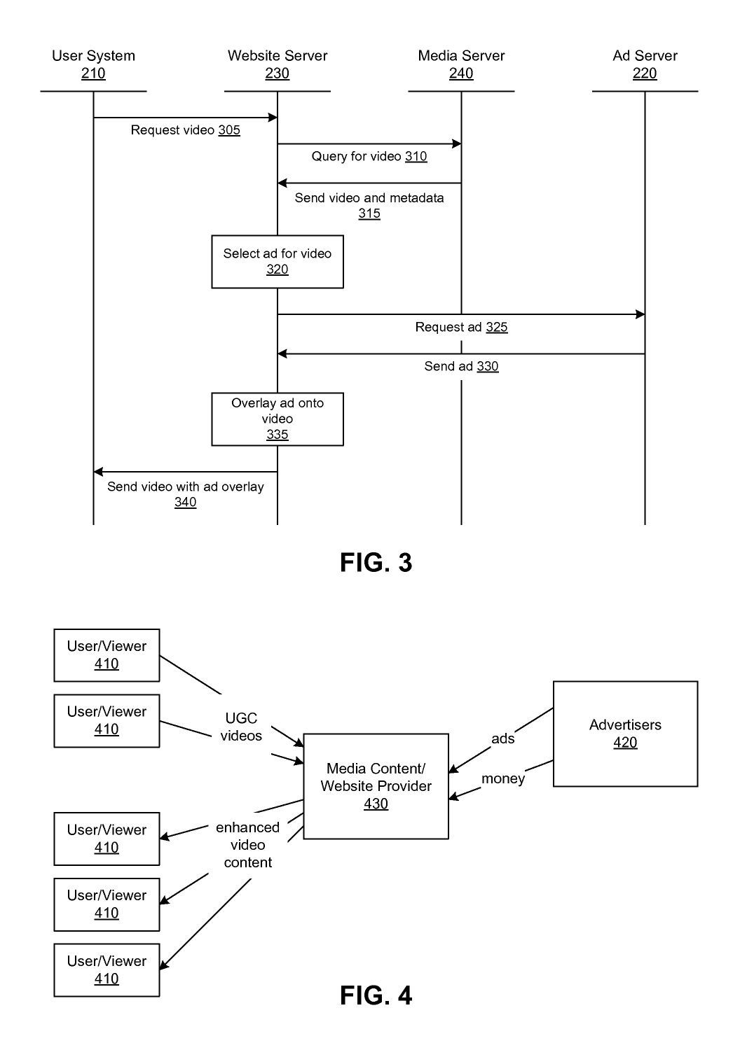

FIG. 3 illustrates a process for associating advertisements with media items and presenting those media items with their associated advertisements to users. In a first step, a viewer uses a user system 210 to request 305 a video clip (or other media item) from a website or other online source. In response, the website server 230 queries 310 the media server 240 for the requested video clip, and in response the media server 240 sends 315 the requested video clip along with metadata related to the video clip. The metadata may include any information about the video clip. In one embodiment, the metadata comprises automatically captured attributes (e.g., file type, file length, and the like) about the video clip and/or manually recorded attributes (e.g., title, description, key words, tag words, and the like).

The website server 230 then selects 320 an advertisement to be combined with the requested video clip. In one embodiment, the website server 230 selects the advertisement using a set of advertisement association criteria, which may be provided by the corresponding business clients and their advertisers.

The website server 230 may use specific criteria (e.g., tag words or phrases, video length, or other information about the media item) to select an appropriate advertisement for the media item. In one embodiment, when a media item that has that metadata is selected for viewing on the website, the website server 230 pulls the appropriate advertisement for the media item. In one embodiment, the media items are video clips, and the advertisements are video overlays that run with the video clip during the video clip. Video overlays may be preferred to advertisements that are presented before or after the video clip, as they cannot be avoided by users who wish to watch only the clip. The association of the video overlay and the digital content may occur on the fly using a dynamic process. As the digital content plays for the viewer, the video overlay is presented at the same time.

The website server 230 then requests 325 the selected advertisement from an advertising server 220, which sends 330 the advertisement to the website server 230. The website server 230 then combines 335 the advertisement with the media item. In one embodiment, the advertisement is presented as an overlay to a video clip. After the website server 230 combines the advertisement with the media item, it delivers 340 the combination to the user system 210 as a unique viewing experience. The combined video output comprises of the requested media item (e.g., video clip) and the advertisement. A link associated with the advertisement may also be presented to the user system 210, at the end of the video clip and/or any time during the playback of the video clip.

The viewer may play back the delivered video clip in a video player module running on the user system 210. In one embodiment, the video player module uses SOAP/Web Service calls to retrieve the video file to be played, any content metadata associated with the video, and any relevant advertising to be overlaid on the video image. The advertisement data may thus be retrieved directly from the advertising server 220. The advertising server 220 may use a variety of criteria to determine which advertisement is most relevant for the video at the time the customer selects it for viewing. If the advertising server 220 finds more than one advertisement for a particular video clip, it may use priority rules to find the best match or otherwise resolve the conflict. The video player module then renders the appropriate advertisement on the video image. The position, size, and duration of the advertisement within the video, as well as which days/time periods the advertisement will run, can be configured by an administrator.

In one embodiment, the media player running on the user system 210 comprises a Flash component that can be activated from a web page. The web page embedding code may include an encrypted 16-character “key” (or identifier) string that identifies the specific video clip to be played. The media player may use web service calls to the digital media server to obtain the URL of the video content, and to the advertising server 220 for metadata that defines the advertisement to be overlaid on the video as it plays. The metadata, returned by the advertising server 220 in a format such as XML, may include information such as position on the screen, fade in/out times, and location of the still image file (for static logos) or animation file (for animations). While the clip is playing, the media player may use Flash “levels” to render the advertisement on top of the video window. It can be appreciated that this is just one of several techniques that can be used to combine advertisements with media items to be delivered to viewers.

In one embodiment, the advertising server 220 uses the video clip's key identifier to look up, in the system database, all relevant metadata for the clip, such as description, title, tag words, and any other automatically captured clip attributes (e.g., duration, media type, and the like). Depending on the advertiser's contract with the customer company, advertisements may be associated with video clips or other media items by tag words, descriptive text, inclusion in a topic/channel, or other criteria. Advertisements can also be configured to start on a specific date and stop on a different date. The advertising server may use database queries to find all ad items that match the media item being played at that particular time. If more than one advertisement matches, the one with highest priority may be returned. If multiple matches have equal priority, then a rotation scheme may be used so that the same advertisement will not be returned in consecutive requests.

The media item and advertisement are typically played by a media player, e.g., on a website accessed by a user's personal computer. Alternatively, the user may download the content for playback at a later time. The system may further include the ability to log the event and process account information, e.g., to facilitate a business model in which the advertiser is charged for the presentation of the advertisement.

Embodiments of the invention enable a business model for advertising in connection with media content sharing, as illustrated in FIG. 4. In one embodiment, one or more advertisers 420 license to the website provider 430 (i.e., the media content provider) the use of the supported website service to power its consumer-generated media site and host the media that is collected thereon. The advertisers 420 may choose to use a hosted ASP version of the website, or they may license the technology and host it within their own data center or structure. The website provider 430 may perform the correlation of the video content and advertising overlays for the advertisers 420. In return, the advertisers 420 gives the website provider 430 a revenue share of advertising deals in addition to or in lieu of operational or license fees.

Advertisers 420 typically act as agents to advertise on behalf of various companies. In embodiments of the model, the advertisers 420 may provide advertisements that link to video displayed on a particular company's website. The website provider 430 may also receive advertisements from advertising aggregators, either by integrating their platform with the website or through other means of advertisement overlay hand-offs.

Viewers 410 of the website can upload media content to the website as well as view content from it. When a viewer 410 requests a media item from the website provider 430, the website provider 430 combines the media item with an advertisement, using for example the techniques described above. In this way, the viewers 410 can view video clips and other media items with an unobtrusive video advertisement overlay and final frame link rather than other sources of advertising on the site. In one embodiment, the viewers 410 do not have to pay for uploading or viewing content, since the fees from the advertisers 420 support the operation of the website provider 430.

In one embodiment, the website is used as an internal promotion solution, linking product information or internal branding to video content. In this way, a company may act on its own behalf in the roles of the advertiser 420 as well as the website provider 430.

Accordingly, revenue for the features described herein may be obtained from licensing or leasing (through the ASP) the functionality as well as through revenue sharing arrangements between the website provider 430 and the advertisers 420. Revenue for the website provider 430 may come from advertisers 420, or the website provider 430 may use the advertising to promote its own internal brand or brands.

As an alternative or in addition to charging for licensing the technology and/or charging a revenue share for advertisements, advertisers 420 may charge directly on a per-click basis.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for pairing advertising with media content delivered by a media sharing website, the method comprising:
receiving a request for a media content item from a requesting device over a network;
obtaining the requested media content item from a media content server;
obtaining metadata that describes an attribute of the content of the media item;
selecting an advertisement for the media item based at least in part on the metadata;
obtaining the selected advertisement from an advertisement server;
combining the advertisement with the media item, wherein the advertisement is combined as an overlay on the media item; and
forwarding the combined media item and advertisement to the requesting device for playback thereon.

2. The method of claim 1, wherein the media item is a video clip, and the advertisement is combined with the media item as an opaque overlay over at least a portion of the video clip.

3. The method of claim 2, wherein the advertisement is combined as an overlay for only a portion of the video clip.

4. The method of claim 1, wherein the advertisement comprises a picture overlay.

5. The method of claim 1, wherein the advertisement comprises a video overlay.

6. The method of claim 1, wherein the advertisement comprises a link to content associated with the metadata.

7. The method of claim 1, wherein selecting the advertisement comprises scoring a plurality of candidate advertisements, and selecting an advertisement having the highest score.

8. A system for pairing advertising with media content delivered by a media sharing website, the system comprising:
a website server configured to receive a request for a media content item from a requesting device over a network, and responsive to the request, to obtain the requested media content item from a media content server and obtain metadata that describes an attribute of the content of the media item, the website server further configured to select an advertisement for the media item based at least in part on the metadata;
an advertisement server configured to provide the selected advertisement responsive to a request from the website server therefor; and
means for combining the advertisement with the media item, wherein the advertisement is combined as an overlay on the media item.

9. The system of claim 8, wherein the website server is configured to forward the combined media item and advertisement to the requesting device for playback thereon.

10. The system of claim 8, wherein the media item is a video clip, and the advertisement is combined with the media item as an opaque overlay over at least a portion of the video clip.

11. The system of claim 10, wherein the advertisement is combined as an overlay for only a portion of the video clip.

12. The system of claim 8, wherein the advertisement comprises a picture overlay.

13. The system of claim 8, wherein the advertisement comprises a video overlay.

14. The system of claim 8, wherein the advertisement comprises a link to content associated with the metadata.

15. The system of claim 8, wherein the website server is configured to select the advertisement comprises scoring a plurality of candidate advertisements, and select an advertisement having the highest score.
